(19) United States
(12) Patent Application Publication
(10) Pub. No.: US 2019/0286126 A1
(43) Pub. Date: Sep. 19, 2019

(54) REMOTE END-POINT DROP-OFF NAVIGATION GUIDANCE

(71) Applicant: GM GLOBAL TECHNOLOGY OPERATIONS LLC, Detroit, MI (US)

(72) Inventors: Nathaniel H. Williams, Berkley, MI (US); Marco T. Carnevale, Windsor (CA); James N. Nickolaou, Clarkston, MI (US); Edgar J. Dietrich, Redwood City, CA (US)

(21) Appl. No.: 15/921,163

(22) Filed: Mar. 14, 2018

(51) Int. Cl. G05D 1/00

(52) U.S. Cl. CPC G05D 1/0061; G05D 1/0011; G05D 1/0088

(57) ABSTRACT

A method and system for autonomously navigating a vehicle toward a passenger route endpoint using a telematics unit installed in the vehicle. The method carried out by the system includes the steps of determining that the vehicle is approaching the passenger route endpoint and remotely navigating the vehicle by identifying a passenger endpoint location near the passenger route endpoint using at least a remote facility separate from the vehicle. The passenger endpoint location may be determined from at least a current or real-time status of a passenger endpoint condition at the passenger route endpoint.

### TECHNICAL FIELD

The present invention relates to systems and methods for autonomous guidance of passenger vehicles particularly when arriving at passenger drop-off or pick-up locations.

### INTRODUCTION

Semi-autonomous and fully autonomous driving systems are being developed which may allow at least partial control of vehicle systems to navigate the vehicle, increasing the degree to which the vehicle takes over driving tasks from vehicle occupants. Semi-autonomous driving systems facilitate partial control of vehicle driving systems, as distinguished from fully autonomous systems which entirely take over guidance of the vehicle from the driver while the system is activated. Autonomous and semi-autonomous driving systems have become generally adept at navigation of vehicles in controlled driving environments or where the roadway is otherwise generally restricted to motor vehicles such as freeways.

However, guidance of autonomous and semi-autonomous vehicles over less restricted roadways, such as city streets where driving conditions are constantly changing in real-time, is more problematic. In such unrestricted driving environments, vehicles may have to navigate amongst other vehicles changing lanes or entering/leaving the flow of traffic, pedestrians, cyclists, or other obstacles that are not easily detected. Guidance may be particularly problematic with respect to navigating near route endpoints (e.g., passenger pickup or drop-off locations), which depends on highly dynamic factors and may be unpredictable. Merely by way of example, the suitability of a particular passenger endpoint may depend on other vehicle traffic, pedestrian and bike traffic, curb availability, weather conditions, and specific desires of the passengers. Vehicle systems may not have adequate processing power to handle the various conditions affecting endpoint suitability in real-time.

Accordingly, there is a need for an improved vehicle navigation system that addresses the above problems.

### SUMMARY

In accordance with one aspect of the invention, there is provided a method of navigating a vehicle. The method includes the steps of: (a) autonomously navigating the vehicle toward a passenger route endpoint using a telematics unit installed in the vehicle; (b) determining the vehicle is approaching the passenger route endpoint; and (c) remotely navigating the vehicle based upon the determination that the vehicle is approaching the passenger route endpoint. Remotely navigating the vehicle may include identifying a passenger endpoint location near the passenger route endpoint using at least a remote facility separate from the vehicle, wherein the passenger endpoint location is determined from at least a real-time status of a passenger endpoint condition.

In one or more embodiments, this method may include any one or any technically feasible combination of the following features:
the method further includes the steps of: (d) receiving a navigation termination command from a passenger of the vehicle before the identified passenger endpoint location is reached by the vehicle; and (e) in response to the received navigation termination command, interrupting navigation of the vehicle to permit passenger ingress or egress before the identified passenger endpoint location is reached by the vehicle.
the method further includes determining a range from the passenger route endpoint for viable pick-up or drop-off locations, wherein the determination in step (b) is made based at least upon the range determined in step (d), and optionally, the range is based upon one of an estimated time for the vehicle to reach the passenger route endpoint and a distance from the vehicle to the passenger route endpoint.
step (c) includes receiving vehicle guidance from a remote operator located at the remote facility.
the passenger endpoint condition includes a temporary traffic condition.
the passenger endpoint condition includes an indication of whether access to a potential endpoint location is available for the vehicle.

In accordance with another aspect of the invention, there is provided a method of navigating a vehicle that includes the steps of: (a) autonomously navigating the vehicle toward a passenger route endpoint using a telematics unit installed in the vehicle; (b) determining the vehicle is approaching the passenger route endpoint, including determining a range from the passenger route endpoint for viable pick-up or drop-off locations, wherein the range is based upon one of an estimated time for the vehicle to reach the passenger route endpoint and a distance from the vehicle to the passenger route endpoint; and (c) remotely navigating the vehicle based upon the determination in step (b), including identifying a passenger endpoint location near the passenger route endpoint using at least a remote facility separate from the vehicle, wherein the passenger endpoint location is determined from at least a real-time status of a passenger endpoint condition.

In one or more embodiments, the method of the preceding paragraph may include any one or any technically feasible combination of the following features:
the method further includes the steps of: (d) receiving a navigation termination command from a passenger of the vehicle before the identified passenger endpoint location is reached by the vehicle; and (e) in response to the received navigation termination command, interrupting navigation of the vehicle to permit passenger ingress or egress before the identified passenger endpoint location is reached by the vehicle.
step (c) includes receiving vehicle guidance from a remote operator located at the remote facility.
the passenger endpoint condition includes a temporary traffic condition.
the passenger endpoint condition includes an indication of whether access to a potential endpoint location is available for the vehicle.

In accordance with another aspect of the invention, there is provided a system for navigating a vehicle. The system may include a telematics unit installed in the vehicle, which is configured to autonomously navigate the vehicle toward a passenger route endpoint. The system further includes a remote facility separate from the vehicle, the remote facility configured to identify a passenger endpoint location near the passenger route endpoint in response to a determination that the vehicle is approaching the passenger route endpoint, based upon at least a real-time status of a passenger endpoint condition at the passenger route endpoint.

In one or more embodiments, this system may include any one or any technically feasible combination of the following features:
the telematics unit is configured to stop navigation of the vehicle to permit passenger ingress or egress before the identified passenger endpoint location is reached by the vehicle in response to receiving a navigation termination command from a passenger of the vehicle.
the telematics unit is configured to determine a range from the passenger route endpoint for viable pick-up or drop-off locations, and optionally, the range is based upon one of an estimated time for the vehicle to reach the passenger route endpoint and a distance from the vehicle to the passenger route endpoint.
the remote facility provides guidance via a remote operator located at the remote facility.
the passenger endpoint condition includes a temporary traffic condition.
the passenger endpoint condition includes an indication of whether access to a potential endpoint location is available for the vehicle.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the exemplary methods disclosed herein;

FIG. 2 is a schematic diagram depicting an embodiment of an autonomous vehicle route including a destination and associated passenger endpoint locations;

FIG. 3A is a schematic diagram depicting an embodiment of an autonomous vehicle route including a destination, available passenger endpoint locations, and zones where passenger pick-ups and drop-offs are restricted or not permitted;

FIG. 3B is another schematic diagram depicting an embodiment of an autonomous vehicle route including a destination, available passenger endpoint locations, and zones where passenger pick-ups and drop-offs are restricted or not permitted;

FIG. 4 is a process flow diagram illustrating exemplary methods of communicating with or guiding one or more vehicles.

### DETAILED DESCRIPTION OF THE ILLUSTRATED EMBODIMENT(S)

In at least some example implementations, a method and/or system for navigating an autonomous vehicle may provide for shifting navigation control to a remote facility as the vehicle nears a destination. In this manner, a remote facility, with additional processing power and access to information that may not be readily accessible to a vehicle, may identify appropriate passenger endpoint locations near the destination based upon conditions affecting suitability of passenger pick-up and drop-off locations in real-time. As used herein, a passenger route endpoint refers to an intended location for either passenger pick-up or drop-off, whereas a passenger endpoint location refers to the particular location at or near the passenger route endpoint where the vehicle stops to pick up the passenger or drop him or her off. Thus, for example, where the passenger desires to be picked up at, or dropped off at, a particular store or restaurant (the passenger route endpoint), the actual location used for stopping to pick up or drop off the passenger may be farther down the street (the passenger endpoint location) where vehicle stopping is possible or permitted. Although the method and system described herein may be used for both passenger pick-up and drop-off, the particular example described below will be directed to dropping off a passenger at a drop-off location (the passenger endpoint location) that is at or near the desired destination (the passenger route endpoint).

In carrying out the navigation method described herein, a remote facility provides support to the vehicle in the form of automated assistance and/or assistance from human or live advisors. As will be described further below, a remote facility communicating with the vehicle may facilitate identification of passenger endpoint locations using any number of different forms of live data or real-time information. By transitioning control of the autonomous vehicle to the remote facility, at least inasmuch as the remote facility identifies one or more endpoint locations, the vehicle need not dedicate additional processing or computing power to the task. Moreover, the additional processing power of the remote facility and/or availability of live personnel to assist with guidance of autonomous vehicle systems may generally allow consideration of various information streams in real-time that are typically beyond the processing/computing abilities of an automated system, such as an autonomous vehicle. In this manner, example illustrations may allow for autonomous vehicles to meet passengers at pick-up locations and deliver passengers to drop-off locations by considering various factors affecting the suitability of a number of endpoint locations near a destination.

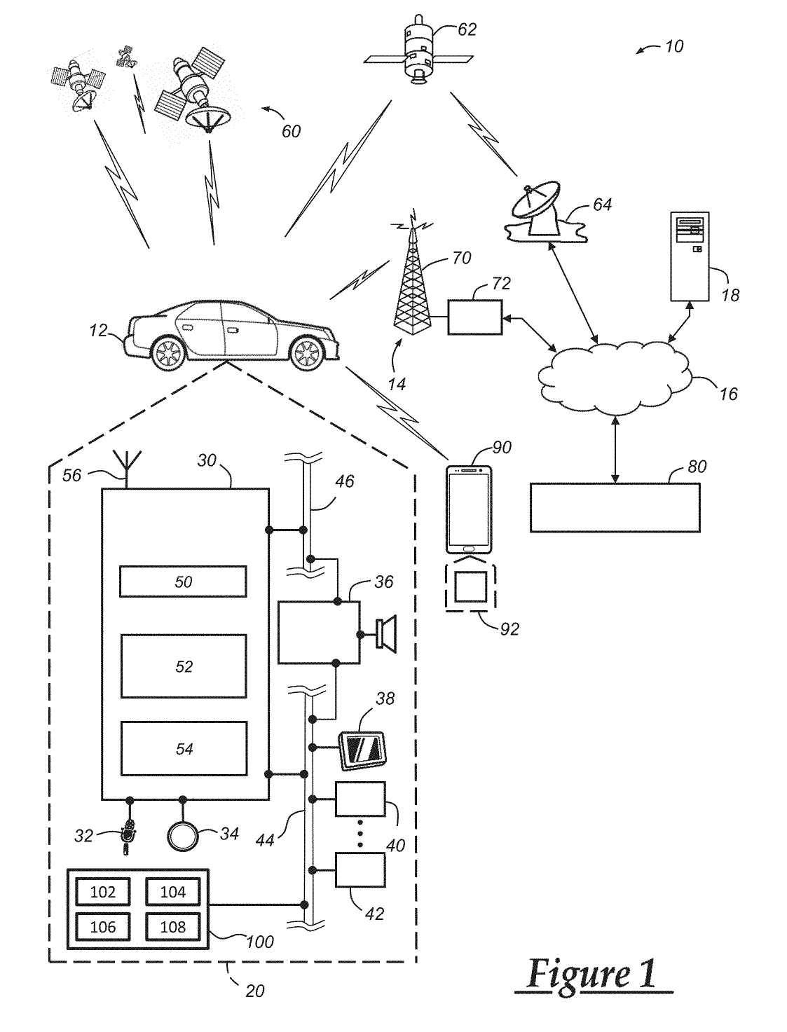

With reference to FIG. 1, there is shown an operating environment that comprises a mobile vehicle communications system 10 and that can be used to implement the methods disclosed herein. Communications system 10 generally includes a vehicle 12, one or more wireless carrier systems 14, a land communications network 16, a computer 18, a remote facility 80, and a mobile device 90. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed methods as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and include a telematics unit 30, a microphone 32, one or more pushbuttons or other control inputs 34, an audio system 36, a visual display 38, a GPS module 40, a cruise control system 100, as well as a number of other vehicle system modules (VSMs) 42. Some of these devices can be connected directly to the telematics unit such as, for example, microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with remote facility 80, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art, or via other wireless communication methods, e.g., SMS/text messages. For combined services that involve both voice communication (e.g., with a live advisor or voice response unit at the remote facility 80) and data communication (e.g., to provide GPS location data or vehicle diagnostic data to the remote facility 80), the system can utilize a single call over a voice channel and switch as needed between voice and data transmission over the voice channel, and this can be done using techniques known to those skilled in the art.

According to one embodiment, telematics unit 30 utilizes cellular communication according to GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to remote facility 80 or other remote computer system, such as computer 18, for other purposes, such as fleet management. Also, new or updated map data can be downloaded to the GPS module 40 from the remote facility 80 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 20 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the remote facility 80. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Adaptive cruise control system 100 controls components of the vehicle power system (e.g., the throttle valve of a vehicle with an internal combustion engine or the power controller regulating power delivery from a vehicle battery to an electric motor in an electric vehicle) and vehicle brake system to maintain a predetermined vehicle speed and/or vehicle position relative to other vehicles. In some examples, the cruise control system 100 provides, at least in part, semi-autonomous driving of the vehicle 12, and in some cases fully autonomous driving of the vehicle 12. Accordingly, in addition to controlling speed and/or position of the vehicle 12 relative to other vehicles, the cruise control system 100 may control steering wheel position of the vehicle 12, or otherwise guide the vehicle 12 by directing the vehicle 12 while the cruise control system 100 is activated. At a minimum, the cruise control system 100 may be a super cruise system, where the vehicle 12 generally guides the vehicle 12 on a road such that a driver can cruise at a desired speed or range of speeds, and need not manually steer the vehicle 12 to maintain the vehicle in a desired lane and/or avoid other vehicles.

System 100 may include a user interface 102, vehicle interface 104, communications module 106 and controller 108. User interface 102 is configured to receive inputs from a driver of vehicle 12 including a desired vehicle speed and desired position relative to other vehicles and to generate outputs to the driver or other vehicle occupants including confirmation of the inputs. The cruise control system 100 may receive other information input by the driver, e.g., a destination point or route, along which the cruise control system 100 is to guide the vehicle 12. The cruise control system 100 may receive such inputs directly from the driver by way of the user interface 102, or from other vehicle components via the vehicle interface 104. For example, the cruise control system 100 may receive instructions or information from the telematics unit 30 over the bus 44. The user interface 102 may include any combination of hardware, software and/or other components that enable the driver to exchange information or data with the vehicle 12. The interface 102 typically includes touch screen displays, pushbuttons or other mechanisms on the instrument panel (or dashboard) or steering column. Vehicle interface 104 is configured to receive input signals from a plurality of sensors used to detect operating conditions of the vehicle including, for example, wheel speed sensors that are coupled to each wheel of vehicle 12 and separately report the rotational velocity of each wheel and sensors that are used to detect the position of other vehicles on the road including, for example, light detection and ranging (LIDAR) devices, ultrasonic devices, radio detection and ranging (RADAR) devices, and vision devices (e.g., cameras, etc.) used in vehicle collision avoidance systems such as a forward collision warning systems, front automatic braking systems, forward or rear park assist systems, lane departure warning systems, side blind zone alert systems, side or rear object detection systems, or rear automatic braking systems. Interface 104 is also configured to transmit output signals to components of the vehicle power system and vehicle brake system for use in controlling the vehicle power system and vehicle brake system. Communications module 106 may include any combination of hardware, software and/or other components that enable wireless voice and/or data communication between system 100 and systems external to vehicle 12 or internal to vehicle 12 such as telematics unit 30. Module 106 may, for example, include a radio transceiver configured for short range wireless communication with telematics unit 30 using short-range wireless technologies such as Wi-Fi (IEEE 802.11), WiMAX, Wi-Fi direct, Bluetooth, Zigbee, near field communication (NFC), etc. in order to obtain geographic information such as updated maps used in predictive control. Controller 108 is configured to generate control signals for the vehicle power system and vehicle brake system responsive to inputs received through the user interface 102, vehicle interface 104 and communications module 106. The controller 108 may include various electronic processing devices (e.g., a microprocessor, a microcontroller, an application specific integrated circuit (ASIC), etc.) and memory devices.

As will be described further below, in some examples the user interface 102 allows for an occupant of the vehicle 12 to provide inputs such as selecting a passenger route endpoint (e.g., a destination), deactivating the cruise control system 100, canceling a navigation request, or the like.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to remote facility 80. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, remote facility 80 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or remote facility 80, or both. A computer 18 can also be used for providing Internet connectivity such as DNS services or as a network address server that uses DHCP or other suitable protocol to assign an IP address to the vehicle 12.

Remote facility 80 is designed to provide the vehicle electronics 20 with a number of different system back-end functions. The remote facility 80 may include one or more switches, servers, databases, live advisors, as well as an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 16. A database at the remote facility can store account information such as subscriber authentication information, vehicle identifiers, profile records, behavioral patterns, and other pertinent subscriber information. Data transmissions may also be conducted by wireless systems, such as 882.11x, GPRS, and the like. Although the illustrated embodiment has been described as it would be used in conjunction with a manned remote facility 80 using a live advisor, it will be appreciated that the remote facility can instead utilize a VRS as an automated advisor or, a combination of the VRS and the live advisor can be used.

The remote facility 80 may include a database of roads, routes, locations, etc. permitted for use with a semi-autonomous or fully autonomous driving system associated with one or more vehicles 12. As will be described further below, the remote facility may communicate with the vehicle(s) 12 to provide route guidance in response to a request received from the vehicle(s) 12, and in some cases may fully control navigation of the vehicle 12. For example, the remote facility 80 may determine passenger endpoint locations based upon information received from vehicle 12 or other sources, which will be described further below.

Mobile device 90 is a non-vehicle device, meaning that it is not a part of vehicle 12 or vehicle electronics 20. The mobile device includes: hardware, software, and/or firmware enabling cellular telecommunications and/or short range wireless communication (SRWC), as well as other wireless device functions and applications. The hardware of mobile device 90 comprises a processor and memory for storing the software, firmware, etc. This memory may include volatile RAM or other temporary powered memory, as well as a non-transitory computer readable medium that stores some or all of the software needed to carry out the various external device functions discussed herein. The mobile device processor and software stored in the memory enable various software applications, which may be preinstalled or installed by the user (or manufacturer) (e.g., having a software application or graphical user interface (GUI)). This may include an application 92 that can allow a vehicle user to communicate with vehicle 12 and/or to control various aspects or functions of the vehicle—e.g., among other things, allowing the user to remotely lock/unlock vehicle doors, turn the vehicle ignition on or off, check the vehicle tire pressures, fuel level, oil life, etc. The application may also be used to enable the user of device 90 to view information pertaining to the vehicle (e.g., the current location of the vehicle, whether the vehicle is locked or unlocked) and/or pertaining to an account associated with the user or vehicle. Wireless device 90 is shown as a smartphone having cellular telephone capabilities. In other embodiments, device 90 may be a tablet, laptop computer, or any other suitable device. In addition, application 92 may also allow the user to connect with the remote facility 80 or call center advisors at any time.

While a single vehicle 12 is illustrated in FIG. 1, in the exemplary methods described below it should be understood that multiple vehicles 12, and in some cases many vehicles 12, may be present. For example, a number of vehicles 12 may be traveling on one or more roads, and communicating with remote facility 80 to provide guidance or other assistance to vehicle 12.

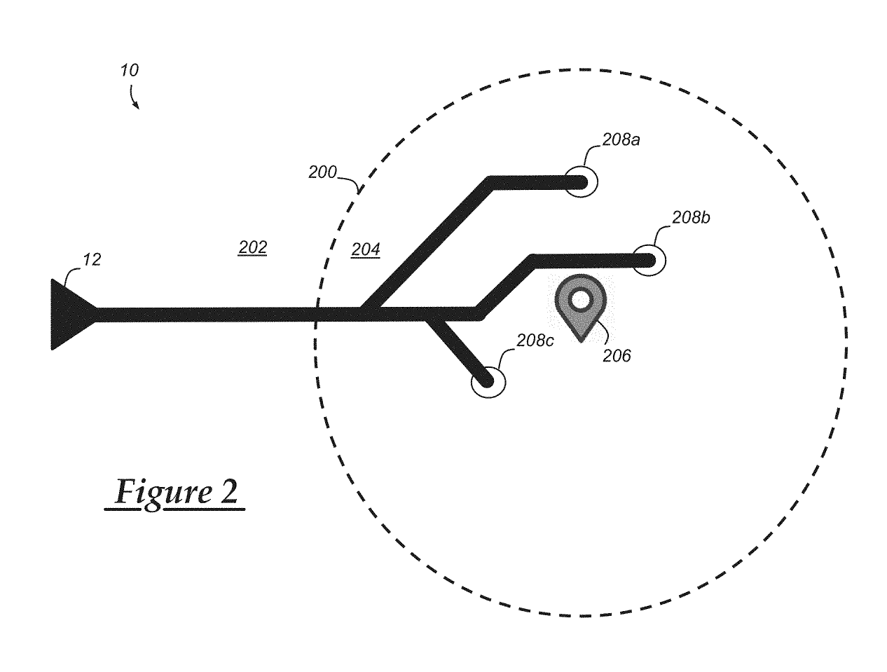

Turning now to FIG. 2, a vehicle 12 is illustrated approaching a passenger route endpoint; in particular a destination 206 at which the passenger desires to be delivered. As the vehicle 12 nears the destination 206, remote facility 80 may provide guidance to the vehicle 12 with regard to particular nearby passenger endpoint locations, as represented by passenger drop-off locations 208a, 208b, 208c (collectively, 208). In applications where the vehicle 12 is not a fully autonomous vehicle such that a live driver must be present to navigate the vehicle 12 at all times, a driver of vehicle 12 may desire to drop off one or more passengers of the vehicle 12 near a passenger destination 206. In applications where the vehicle 12 is capable of fully autonomous operation, the vehicle 12 may be dropping off one or more passengers near the passenger destination 206.

Drop-off locations 208 may include any convenient position near the passenger destination 206 for stopping the vehicle 12 to allow egress of one or more passengers. Merely by way of example, drop-off locations 208 may include curbside locations where stopping, standing, or parking of vehicles is permitted, parking lots, entrances/exits associated with passenger destination 206, or the like.

The drop-off locations 208 may be identified based upon a proximity to passenger destination 206. In some examples, a range limit 200 is used to determine suitability of drop-off locations 208, at least to determine an initial list of drop-off locations 208. In one example approach, a distance limit is used to determine the range limit 200, such that only drop-off locations within the distance limit are analyzed. In another example, a travel time to the passenger destination 206 from the drop-off locations 208 is used, e.g., such that passenger drop-off locations 208 must be within a certain walking time to the passenger destination 206.

As noted above, a variety of real-time conditions may affect relative suitability of the passenger drop-off locations 208. Remote facility 80 may monitor such conditions or characteristics and provide guidance to the vehicle 12, including but not limited to identification of suitable passenger drop-off locations 208. While passenger drop-off locations 208 may be identified using any characteristics that are convenient, locations may in some examples be identified in a manner to facilitate safer or otherwise better exit and entry for passengers of vehicle 12.

Merely as examples, conditions affecting drop-off location suitability may include the presence/location of other vehicle traffic, foot and bike traffic, other vehicles parked on streets or in parking lots, bike lanes, temporary parking/loading zones, and/or road repair or other construction. Additional factors may include availability of curb space for passenger/vehicle access, weather conditions, police/emergency activities in the vicinity, specified desires of the customers/riders, merely as examples. These volatile factors mean that finding ideal safe and reliable stopping spots for pick-up and drop-off scenarios could require more local data and computing capability than may be available at the vehicle.

In other examples, historical or static information may be used to identify a suitable drop-off location 208. As one basic example, time of day and expected traffic patterns, e.g., due to rush hour traffic, scheduled events in the vicinity of the vehicle 12 and/or passenger drop-off locations 208, or the like, may be used as inputs. Merely as examples, in addition to the static location of bus stops, bus lanes, or the like, schedules for busses or other public transportation potentially affecting the suitability of passenger drop-off location(s) 208 may be used. Moreover, information provided by the vehicle 12 may be used to update schedules, for example, to identify locations of busses to the extent they may deviate from schedule.

Other historical data may include, depending on the time of day, lighting near the drop-off location(s) 208. Further, historical crime data may be used to determine best drop-off locations 208.

Remote facility 80 may obtain information to determine appropriate passenger drop-off locations using on-board sensors/systems of the vehicle 12, as well as sources external to the vehicle. The remote facility 80 may process the information, via a live advisor or automated systems, and then provide guidance to the vehicle 12 to better target an ideal safe stopping spot to safely allow passengers to exit and/or enter the vehicle 12. Remote facility 80 may use infrastructure, vehicle sensor data, fleet data, or any other available information to obtain an accurate “picture” of what drop-off locations 208 are likely to be available. Additionally, the remote facility 80 may eliminate drop-off locations that are particularly busy, obstructed, experiencing increased traffic, etc., to identify drop-off locations 208 that within a predetermined range of the passenger destination 206 and suitable for dropping off a passenger. Moreover, in some examples remote facility 80 may provide updated guidance routes based upon identified passenger drop-off locations 208.

Examples of inputs external to the vehicle 12 that may be used to determine a suitable drop-off location 208 may include camera feeds in areas near the passenger destination 206 and/or drop-off location(s) 208. In some examples, cameras or camera arrays in convenient locations may be utilized through virtual reality systems by a live advisor in order to allow the remote facility 80 or operators there to have a remote reality experience relative to potential passenger drop-off locations 208. Visual information from other vehicles, e.g., from a fleet system associated with remote facility 80 (or otherwise available to the remote facility 80), may also be provided to remote facility 80. Visual information from other camera systems placed at the location of the vehicle 12 may also be used to the extent they are available to the public or remote facility 80.

Other examples of potential sources of information external to the vehicle 12 may include parking indicators, intersection/traffic cameras, other visual data collected via microsatellites or drones, accident data, or the like.

Visual data may be collected and presented by remote facility 80, e.g., to a live advisor, in any manner convenient to allow the advisor to select a suitable drop-off location(s) 208. For example, visual information may be provided by way of a map or other representation of the vehicle 12 and the location of the vehicle 12, with vehicle object detection data overlaid on top of other information received by the remote facility 80.

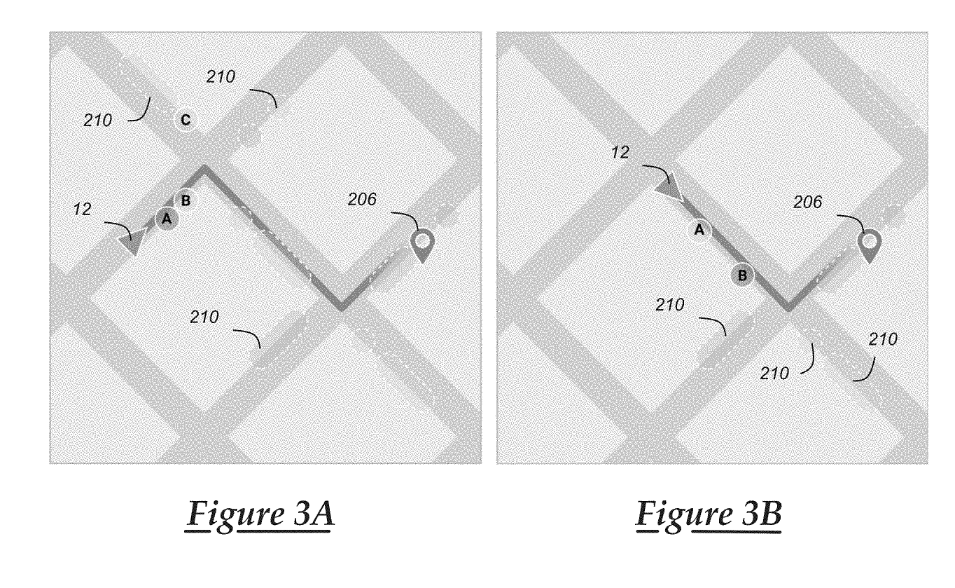

Turning now to FIGS. 3A and 3B, examples are provided of visual representations that may be used to aggregate information received from vehicle 12 and/or external sources, in order to allow selection by a live advisor at remote facility 80 or by a passenger of the vehicle 12. In each example, potential drop-off zones may be identified along with areas where drop-offs are unsafe or otherwise unsuitable. In FIG. 3A, for example, vehicle 12 is illustrated as traveling to destination 206, and has two options (“A” and “B”) identified on the map. Additionally, other zones 210 are illustrated on the map, e.g., to identify areas where a drop-off is not suitable, e.g., due to traffic, obstructions, lack of curb space, etc. Similarly, in FIG. 3B three drop-off locations (“A,” “B,” and “C”) are identified visually in relation to vehicle 12, the passenger destination 206, and unsuitable drop-off zones 210.

The remote facility 80 may provide inputs to the vehicle 12 to provide one or more suitable passenger drop-off locations 208. In some examples, remote facility 80 may provide a selection of a limited set of drop-off locations 208 to the vehicle 12. In other examples, these options may limit autonomous guidance of the vehicle 12. In another example, drop-off locations 208 may be provided to vehicle 12 for the driver/passenger to accept or choose, and may thus provide an updated navigation destination.

Remote facility 80 may also strategically determine an approach route to a passenger destination 206 in order to maximize passing of the most suitable drop-off locations 208, or the largest number of drop-off locations. Merely as one example, drop-off location 208a may have a 60% availability rate based on historical data, while drop-off location 208b may have a relatively lower availability rate. Continuing with this example, on the basis of the historically greater availability rate, a route for vehicle 12 may be chosen with the relatively higher availability rate of the drop-off location 208a as compared with that of drop-off location 208b in mind.

As noted above, a user interface 102 may allow for occupants of the vehicle 12 to select passenger drop-off locations, cease navigation, modify routes, etc. The user interface 102 may also allow vehicle occupants to view a map of verified drop-off spots known to be suitable, e.g., in relation to a location of the vehicle 12 and passenger destination 206. In some examples, safety confidence ratings may be provided, e.g., based on location, distance to intersections, cross walks, map data, zone information, traffic, etc.

The passenger cutoff feature may generally allow passenger(s) to exit the vehicle, e.g., if the vehicle 12 is stopped in traffic near destination, or if the passenger observes a pothole, puddle, or other obstruction, so that the passenger(s) may exit and walk the remaining distance to the passenger destination 206. The user interface 102 may allow verbal commands, thereby generally seamlessly permitting passengers to take over control of the selection process of the passenger drop-off location(s) 208.

The user interface 102 may also facilitate passengers providing preferences, e.g., maximum or preferred walking distances, which may be used initially by the vehicle 12 and/or remote facility 80 to identify suitable drop-off locations 208. In this manner, passengers can initially help an autonomous system better determine ideal locations for drop-off/pick-up events according to their preferences. Moreover, in some examples historical data or usage in the vehicle 12 may be used to inform identification of passenger drop-off locations 208, rather than requiring preferences to be supplied by passengers. For example, if passengers of vehicle 12 historically select or accept viable drop-off spots of no more than a certain distance away, this distance may be kept in mind when the passenger drop-off locations 208 are initially analyzed for suitability.

The vehicle 12 may also generally look “ahead” in a given navigation route to facilitate avoidance of problem areas. For example, a passenger may be presented with options for a drop-off location 208 in advance of reaching the destination, in an effort to avoid the vehicle 12 becoming stuck in traffic or other issues nearer the destination.

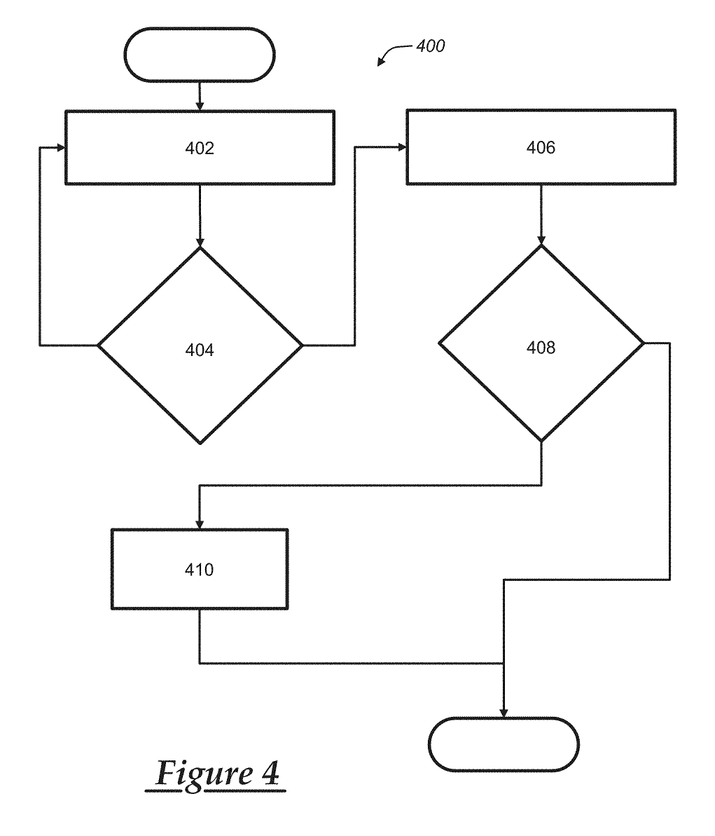

Turning now to FIG. 4, an example method of navigating a vehicle is illustrated. As noted above, example illustrations may be applied to autonomous or traditional driver-operated vehicles. Accordingly, process 400 may begin at block 402, where a vehicle is navigated toward a passenger destination using a telematics unit installed in the vehicle. In one example, telematics unit 30 may provide route guidance to the vehicle 12, thereby assisting a driver operator of the vehicle 12. In another example, vehicle 12 may be navigated autonomously or semi-autonomously. Process 400 may then proceed to block 404.

At block 404, process 400 may query whether the vehicle is approaching the passenger destination. For example, as noted above a range limit 200 for potential drop-off locations 208a, 208b, 208c may be used as an indication the vehicle 12 is approaching the passenger destination 206. The range limit 200 may be associated with a time or distance to passenger destination 206. If the vehicle is not approaching the passenger destination 206, process 400 proceeds back to block 402 to continue normal guidance or navigation.

If the vehicle is approaching or within the range limit 200, process 400 may proceed to block 406. At block 406, the vehicle may be remotely navigated, including identification of one or more passenger drop-off locations near the passenger destination, using at least a remote facility separate from the vehicle. For example, remote facility 80 may provide analysis of real-time conditions near the passenger destination 206 and/or passenger drop-off locations 208a, 208b, 208c, thereby reducing processing demands on the vehicle 12. Remote facility 80 may employ live personnel or advisors, or may employ automated systems that facilitate identification and/or selection of passenger drop-off locations. Process 400 may then proceed to block 408.

At block 408, process 400 may query whether a navigation termination command has been received from a passenger of the vehicle before the identified passenger drop-off location is reached by the vehicle. More specifically, as noted above a user interface 102 may allow a passenger to terminate navigation of a vehicle 12 in autonomous or semi-autonomous settings. In this manner, a passenger may interrupt navigation, e.g., if the vehicle 12 has become stuck in traffic or otherwise prevented from reaching a passenger drop-off location 208. If a navigation termination command has been received, process 400 may terminate, interrupting navigation of the vehicle to permit passenger egress before the identified passenger drop-off location is reached by the vehicle.

Alternatively, if a termination command has not been received from the passenger(s), process 400 proceeds to block 410. At block 410, the vehicle 12 proceeds to the selected drop-off location. Process 400 may then terminate.

The foregoing systems and methods may generally allow for more efficient guidance of a vehicle, whether autonomous or not, to passenger drop-off locations by utilizing remote facilities for guidance support. Additionally, passenger intervention may allow for direct feedback from passenger(s) of the vehicle to modify or cease guidance.

While the foregoing examples are generally directed to assisting driver-operated vehicles and guidance of autonomous or semi-autonomous vehicles, potential applications for the concepts described herein may also include overwatch of autonomous vehicles. For example, when an autonomous vehicle that is stopped, or confused by its local sensor data, remote facility 80 may provide assistance. In one example, a temporary obstruction such as a fallen tree may block a route otherwise typically available, and in such cases remote facility 80 may provide the autonomous vehicle 12 with assistance by assessing the situation and navigating around it safely.

Remote facility may also provide direct guidance of the vehicle 12, e.g., by guiding the vehicle 12 in unmapped areas of lower-speed travel, such as parking lots, garages, or the like.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of navigating a vehicle, comprising:
(a) autonomously navigating the vehicle toward a passenger route endpoint using a telematics unit installed in the vehicle;
(b) determining the vehicle is approaching the passenger route endpoint; and
(c) remotely navigating the vehicle based upon the determination in step (b), including identifying a passenger endpoint location near the passenger route endpoint using at least a remote facility separate from the vehicle, wherein the passenger endpoint location is determined from at least a real-time status of a passenger endpoint condition.

2. The method of claim 1, further comprising:
(d) receiving a navigation termination command from a passenger of the vehicle before the identified passenger endpoint location is reached by the vehicle; and
(e) in response to the received navigation termination command, interrupting navigation of the vehicle to permit passenger ingress or egress before the identified passenger endpoint location is reached by the vehicle.

3. The method of claim 1, further comprising:
(d) determining a range from the passenger route endpoint for viable pick-up or drop-off locations, wherein the determination in step (b) is made based at least upon the range determined in step (d).

4. The method of claim 3, wherein the range is based upon one of an estimated time for the vehicle to reach the passenger route endpoint and a distance from the vehicle to the passenger route endpoint.

5. The method of claim 1, wherein step (c) includes receiving vehicle guidance from a remote operator located at the remote facility.

6. The method of claim 1, wherein the passenger endpoint condition includes a temporary traffic condition.

7. The method of claim 1, wherein the passenger endpoint condition includes an indication of whether access to a potential endpoint location is available for the vehicle.

8. A method of navigating a vehicle, comprising:
(a) autonomously navigating the vehicle toward a passenger route endpoint using a telematics unit installed in the vehicle;
(b) determining the vehicle is approaching the passenger route endpoint, including determining a range from the passenger route endpoint for viable pick-up or drop-off locations, wherein the range is based upon one of an estimated time for the vehicle to reach the passenger route endpoint and a distance from the vehicle to the passenger route endpoint; and
(c) remotely navigating the vehicle based upon the determination in step (b), including identifying a passenger endpoint location near the passenger route endpoint using at least a remote facility separate from the vehicle, wherein the passenger endpoint location is determined from at least a real-time status of a passenger endpoint condition.

9. The method of claim 8, further comprising:
(d) receiving a navigation termination command from a passenger of the vehicle before the identified passenger endpoint location is reached by the vehicle; and
(e) in response to the received navigation termination command, interrupting navigation of the vehicle to permit passenger ingress or egress before the identified passenger endpoint location is reached by the vehicle.

10. The method of claim 8, wherein step (c) includes receiving vehicle guidance from a remote operator located at the remote facility.

11. The method of claim 8, wherein the passenger endpoint condition includes a temporary traffic condition.

12. The method of claim 8, wherein the passenger endpoint condition includes an indication of whether access to a potential endpoint location is available for the vehicle.

13. A system for navigating a vehicle, comprising:
a telematics unit installed in the vehicle, the telematics unit configured to autonomously navigate the vehicle toward a passenger route endpoint; and
a remote facility separate from the vehicle, the remote facility configured to identify a passenger endpoint location near the passenger route endpoint in response to a determination that the vehicle is approaching the passenger route endpoint, based upon at least a real-time status of a passenger endpoint condition at the passenger route endpoint.

14. The system of claim 13, wherein the telematics unit is configured to stop navigation of the vehicle to permit passenger ingress or egress before the identified passenger endpoint location is reached by the vehicle in response to receiving a navigation termination command from a passenger of the vehicle.

15. The system of claim 13, wherein the telematics unit is configured to determine a range from the passenger route endpoint for viable pick-up or drop-off locations.

16. The system of claim 13, wherein the range is based upon one of an estimated time for the vehicle to reach the passenger route endpoint and a distance from the vehicle to the passenger route endpoint.

17. The system of claim 13, wherein the remote facility provides guidance via a remote operator located at the remote facility.

18. The system of claim 13, wherein the passenger endpoint condition includes a temporary traffic condition.

19. The system of claim 13, wherein the passenger endpoint condition includes an indication of whether access to a potential endpoint location is available for the vehicle.
